(19) United States
(12) Patent Application Publication
(10) Pub. No.: US 2006/0137688 A1
(43) Pub. Date: Jun. 29, 2006

(54) Medical devices manufactured from conductively doped resin-based materials

(76) Inventor: Thomas Aisenbrey, Littleton, CO (US)

Correspondence Address: DOUGLAS R. SCHNABEL, 1531 WEDGEWOOD PLACE, ESSEXVILLE, MI, 48732, US

(21) Appl. No.: 11/335,362

(22) Filed: Jan. 19, 2006

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/645,369, filed on Jan. 19, 2005.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. A62B 18/02

(52) U.S. Cl. 128/205.25

(57) ABSTRACT

Medical devices are formed of a conductively doped resin-based material. The conductively doped resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductively doped resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application claims priority to the U.S. Provisional Patent Application 60/645,369, filed on Jan. 19, 2005, which is herein incorporated by reference in its entirety.

This Patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to medical devices, and, more particularly, to medical devices molded of conductively doped resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

(2) Description of the Prior Art

Modern medical devices combine a variety of technical functions for the diagnosis and treatment of disease and injury. Medical devices often need to combine capabilities such as electrical conductivity and electromagnetic resonance into relatively small packages that are safe for use on, or inside, the human body. Unlike pharmaceuticals, medical devices must be formed of materials that do not react, or are inert, with respect to the body of the patient. Typically, where the medical device should be electrically conductive, a metal material must be used. However, many metals will react with the body. Some types of polymer materials are inert, but typically are non-conductive. A primary object of the present invention is to provide medical devices constructed from a material that exhibits excellent properties of electrical and thermal conductivity, electromagnetic resonance, magnetism, acoustical resonance, strength, and inertness, when used on or in the human body.

Several prior art inventions relate to medical devices and conductive polymers. U.S. Patent Publication US 2002/0007128 A1 to Ives et al teaches a method and apparatus for recording an electroencephalogram during trans-cranial magnetic stimulation that utilizes an electrode formed of conductive plastic and coated with a conductive epoxy. U.S. Patent Publication US 2002/0036019 A01 to Woelfel et al teaches a multi-lumen flexible corrugated hose for use with various respiratory treatment machines that have an inner partition of thermally conductive plastic material. U.S. Patent Publication US 2003/0123613 A1 to Evans et al teaches a phosphor imaging plate and cassette handling system that uses an interior conductive fabric layer covering a grounded plastic member in the cassette for antistatic purposes. U.S. Patent Publication US 2004/0059384 A1 to Yu teaches a lower frequency health assistor that utilizes a conductive plastic film for making contact with the acupuncture points of a human body. U.S. Patent Publication US 2004/0051047 A1 to Arakawa teaches a radiation image sensor for use in a medical radiation imaging that uses a conductive resin film layer between the radiation detector layer and the electric signal detector layer. U.S. Pat. No. 6,197,025 to Grossi et al teaches a resectoscope device having a metal electrode.

### SUMMARY OF THE INVENTION

Summarize Objects Of Invention Later

A principal object of the present invention is to provide an effective medical device.

A further object of the present invention is to provide a method to form a medical device.

A further object of the present invention is to provide a medical device molded of conductively doped resin-based materials.

A yet further object of the present invention is to provide an electrical stimulation device comprising conductively doped resin-based material.

A yet further object of the present invention is to provide a probe device comprising conductively doped resin-based material.

A yet further object of the present invention is to provide a radio transmitting or receiving device comprising conductively doped resin-based material.

A yet further object of the present invention is to provide an anti-static breathing mask device comprising conductively doped resin-based material.

A yet further object of the present invention is to provide an electrode patch device comprising conductively doped resin-based material.

A yet further object of the present invention is to provide an electric scalpel device comprising conductively doped resin-based material.

A yet further object of the present invention is to provide a cauterization device comprising conductively doped resin-based material.

A yet further object of the present invention is to provide a medical device molded of conductively doped resin-based material where the thermal, electrical, acoustical, or electromagnetic characteristics can be altered or the visual characteristics can be altered by forming a metal layer over the conductively doped resin-based material.

A yet further object of the present invention is to provide methods to fabricate a medical device from a conductively doped resin-based material incorporating various forms of the material.

A yet further object of the present invention is to provide a method to fabricate a medical device from a conductively doped resin-based material where the material is in the form of a fabric.

In accordance with the objects of this invention, a medical device is achieved. The device comprises an enclosure that is implanted into body tissue. A radio circuit is capable of receiving or transmitting. The radio circuit is within the enclosure. Am antenna is coupled to the radio circuit. The antenna comprises a conductively doped resin-based material comprising conductive materials in a base resin host.

Also in accordance with the objects of this invention, a medical device is achieved. The device comprises a gas source and a face mask operably coupled to the gas source such that gas flows from the gas source and through the face mask. The face mask comprises the conductively doped resin-based material.

### BRIEF DESCRIPTION OF THE DRAWINGS

In the accompanying drawings forming a material part of this description, there is shown:

FIG. 1 illustrates an embodiment of an internal bone growth stimulator comprising a conductively doped resin-based material.

FIG. 2 illustrates an embodiment of a conductively doped resin-based material wherein the conductive materials comprise a powder.

FIG. 3 illustrates an embodiment of a conductively doped resin-based material wherein the conductive materials comprise micron conductive fibers.

FIG. 4 illustrates an embodiment of a conductively doped resin-based material wherein the conductive materials comprise both conductive powder and micron conductive fibers.

FIGS. 5a and 5b illustrate an embodiment wherein conductive fabric-like materials are formed from the conductively doped resin-based material.

FIGS. 6a and 6b illustrate, in simplified schematic form, an injection molding apparatus and an extrusion molding apparatus that may be used to mold medical devices of a conductively doped resin-based material.

FIG. 7 illustrates an embodiment of a neurological test probe comprising a conductively doped resin-based material.

FIG. 8 illustrates an embodiment of ring electrodes comprising a conductively doped resin-based material.

FIG. 9 illustrates an embodiment of a medical camera capsule comprising a conductively doped resin-based material.

FIG. 10 illustrates an embodiment of an oxygen mask comprising a conductively doped resin-based material.

FIG. 11 illustrates an embodiment of a patch electrode device comprising a conductively doped resin-based material.

FIGS. 12a and 12b illustrate an embodiment of an electric scalpel device comprising a conductively doped resin-based material.

FIG. 13 illustrates an embodiment of a cauterizing device comprising a conductively doped resin-based material.

### DESCRIPTION OF THE PREFERRED EMBODIMENTS

This invention relates to medical devices molded of conductively doped resin-based materials comprising micron conductive powders, micron conductive fibers, or a combination thereof, substantially homogenized within a base resin when molded.

The conductively doped resin-based materials of the invention are base resins doped with conductive materials to convert the base resin from an insulator to a conductor. The base resin provides structural integrity to the molded part. The doping material, such as micron conductive fibers, micron conductive powders, or a combination thereof, is substantially homogenized within the resin during the molding process. The resulting conductively doped resin-based material provides electrical, thermal, and acoustical continuity.

The conductively doped resin-based materials can be molded, extruded or the like to provide almost any desired shape or size. The molded conductively doped resin-based materials can also be cut, stamped, or vacuumed formed from an injection molded or extruded sheet or bar stock, over-molded, laminated, milled or the like to provide the desired shape and size. The thermal, electrical, and acoustical continuity and/or conductivity characteristics of articles or parts fabricated using conductively doped resin-based materials depend on the composition of the conductively doped resin-based materials. The type of base resin, the type of doping material, and the relative percentage of doping material incorporated into the base resin can be adjusted to achieve the desired structural, electrical, or other physical characteristics of the molded material. The selected materials used to fabricate the articles or devices are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In the conductively doped resin-based material, electrons travel from point to point, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive doping concentration and material makeup, that is, the separation between the conductive doping particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductively doped resin-based material are altered when molded into a structure. A substantially homogenized conductive microstructure of delocalized valance electrons is created within the valance and conduction bands of the molecules. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

Conductively doped resin-based materials lower the cost of materials and of the design and manufacturing processes needed for fabrication of molded articles while maintaining close manufacturing tolerances. The molded articles can be manufactured into infinite shapes and sizes using conventional forming methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopant(s), the doping parameters and/or the base resin selection(s).

The conductively doped resin-based materials comprise micron conductive powders, micron conductive fibers, or any combination thereof, which are substantially homogenized together within the base resin, during the molding process, yielding an easy to produce low cost, electrical, thermal, and acoustical performing, close tolerance manufactured part or circuit. The resulting molded article comprises a three dimensional, continuous capillary network of conductive doping particles contained and or bonding within the polymer matrix. Exemplary micron conductive powders include carbons, graphites, amines, eeonomers, or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, melamine, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

Where micron fiber is combined with base resin, the micron fiber may be pretreated to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-diffusion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment fiber modification also reduces levels of particle dust, fines, and fiber release during subsequent capsule sectioning, cutting or vacuum line feeding.

The resin-based structural material may be any polymer resin or combination of compatible polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material doped with micron conductive powders, micron conductive fibers, or in combination thereof can be molded, using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductively doped resin-based material may also be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber created by the moldable capsules. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

As an additional and important feature of the present invention, the molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage of the present invention, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the conductively doped resin-based material, any of several techniques may be used to form this metal layer. This metal layer may be used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire can easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can be used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive doping may be combined with a non-ferromagnetic conductive doping to form a conductively doped resin-based material that combines excellent conductive qualities with magnetic capabilities.

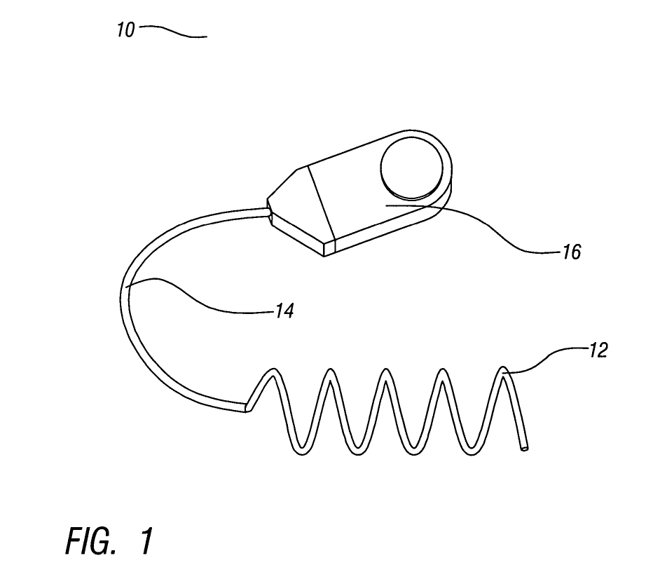

Referring now to FIG. 1, an embodiment of a medical device is illustrated. In particular, an internal bone growth stimulator 10 is shown. Electrical bone growth stimulation is a process used to speed the healing of difficult to heal bone fractures. The technique utilizes a low voltage electrical current applied to a fracture area. Healing is stimulated by negatively charging a concave side of a bone and positively charging the convex side of a bone. By artificially generating charge via an electric current, the healing process is accelerated. Electrical bone growth stimulators are designed to be either fully or partially implantable. Fully implantable stimulators are installed under general or regional anesthesia. Both the stimulator and the power source are implanted and require no patient interaction for their operation. The spiral shaped cathode is placed inside or along side the bone fracture. A wire leads to a power source and an anode that are placed in a nearby muscle. The partially implanted stimulators utilize cathode pins that are implanted at the edge of the fracture with a wire connecting to the surface of the skin where the battery pack and anode are located.

The bone growth stimulator 10 of the present invention utilizes the unique material properties of the conductively doped resin-based material. In particular, any component, or several components, of the internal bone growth stimulator 10 comprise the conductively doped resin-based material of the present invention. In various embodiments, the cathode 12, the conductor 14, and/or the battery pack casing 16, are formed of the conductively doped resin-based material of the present invention. An FDA approved, medical grade resin is used for the base resin of the conductively doped resin-based material.

In one embodiment the cathode 12 comprises the conductively doped resin-based material of the present invention. The cathode 12 formed of the conductively doped resin-based material offers excellent electrical conductivity with a lower production cost than a metal cathode. The ability for more intricate design structures is also realized when forming cathodes 12 of the conductively doped resin-based material of the present invention.

In one embodiment the cathode 12 is formed entirely of the conductively doped resin-based. In another embodiment, the cathode 12 is formed of the conductively doped resin-based material and then metal plated and/or metal coated. In yet another embodiment the cathode is formed of metal onto which an outer layer of the conductively doped resin-based material is applied, to provide a non-corroding, yet conductive, outer layer.

In one embodiment the conductor 14 comprises the conductively doped resin-based material. In one embodiment the conductor 14 is formed with the conductively doped resin-based material as the inner conductive core and an outer layer of non conductive resin-based material. In another embodiment the conductor 14 is formed with an inner conductive core of metal, a surrounding layer of conductively doped resin-based material, and an outer layer of non conductive resin-based material. In one embodiment, the conductor 14 and cathode 12 are formed as a continuous piece of conductively doped resin-based material. In another embodiment, the conductor 14 is conductively doped resin-based material and the cathode 12 is a metal wire that is soldered or otherwise electrically connected to the conductor 14.

In one embodiment of the present invention, a battery pack casing 16 comprises conductively doped resin-based material. The battery pack casing 16 serves the dual purpose of holding the battery and of acting as the anode to complete the electrical circuit. In one embodiment the battery pack casing 16 is formed entirely of the conductively doped resin-based material of the present invention. In another embodiment the battery pack casing 16 is formed of the conductively doped resin-based material and then metal plated and/or metal coated. In yet another embodiment the battery pack casing 16 is formed of metal with an outer layer of conductively doped resin-based material to isolate the metal from body tissue.

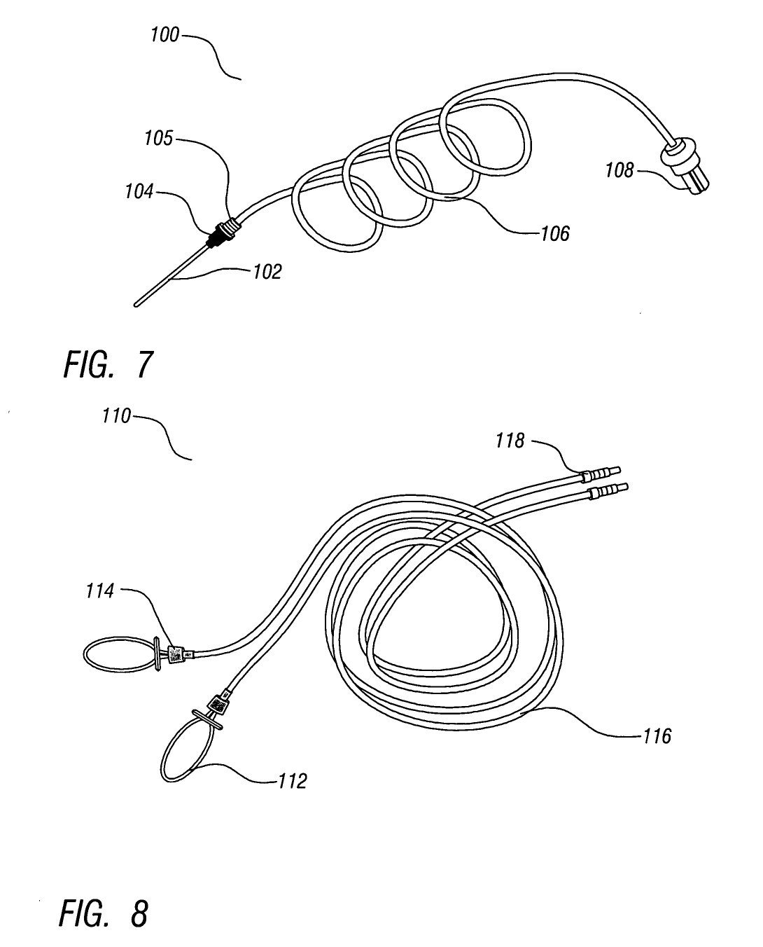

Referring now to FIG. 7, another medical device of the present is illustrated. In particular, an embodiment of a neurological test probe 100 is shown. The neurological test probe 100 comprises the conductively doped resin-based material of the present invention. In various embodiments, a needle 102, a needle connector 104, a conductor 106, and/or a terminal connector 108, are formed of the conductively doped resin-based material of the present invention. An FDA approved, medical grade resin is used for the base resin of the conductively doped resin-based material.

In one embodiment of the present invention the needle 102 comprises the conductively doped resin-based material. The needle 102 formed of the conductively doped resin-based material offers excellent electrical conductivity at lower cost than a metal formed needle. In one embodiment of the present invention the needle connector 104 comprises the conductively doped resin-based material. In one embodiment the needle connector 104 is formed entirely of the conductively doped resin-based material and then covered with an outer layer of non conductive resin-based material to electrically insulate the needle 102. In another embodiment the needle connector 104 is formed of the conductively doped resin-based material, metal plated and/or metal coated, and then covered with an outer layer of non conductive resin-based material. In one embodiment the needle connector 104 is formed along with the needle 102. In another embodiment the needle connector 104 is formed of the conductively doped resin-based material, the needle 102 is metal, and the needle 102 is soldered or otherwise electrically connected to the needle connector 104.

In one embodiment of the present invention the conductor 106 comprises the conductively doped resin-based material. In one embodiment the conductor 106 is formed with the conductively doped resin-based material as the inner conductive core with an outer layer of non conductive resin-based material for electrical insulation. In another embodiment the conductor 106 comprises an inner conductive core of metal, a surrounding layer of conductively doped resin-based material, and an outer layer of non conductive resin-based material. In one embodiment the conductor 106 is formed along with the needle connector 105 and terminal connector 108. In another embodiment the conductor 106 is metal and the connector 105 and terminal connector 108 are formed of the conductively doped resin-based material. The connector 105 and the terminal connector 108 are soldered or otherwise electrically connected to the conductor 106.

In one embodiment of the present invention the terminal connector 108 comprises the conductively doped resin-based material. In one embodiment the terminal connector 108 is formed entirely of the conductively doped resin-based material and then covered with an outer layer of non conductive resin-based material for electrical insulation. In another embodiment the terminal connector 108 is formed of the conductively doped resin-based material, metal plated and/or metal coated, and then covered with an outer layer of non conductive resin-based material.

Referring now to FIG. 8, another embodiment of a medical device of the present invention is illustrated. In particular, an embodiment of ring electrodes 110 is shown. The ring electrodes 110 comprise the conductively doped resin-based material of the present invention. In various embodiments, ring loops 112, ring loop connectors 114, conductors 116, and/or terminal connectors 118, are formed of the conductively doped resin-based material of the present invention. An FDA approved, medical grade resin is used for the base resin of the conductively doped resin-based material.

In one embodiment of the present invention the ring loops 112 comprises the conductively doped resin-based material. The ring loops 112 formed of the conductively doped resin-based material offer excellent electrical conductivity at lower cost than a metal formed ring electrode. In one embodiment the ring loop connectors 114 comprise only the conductively doped resin-based material. In one embodiment the ring loop connectors 114 are formed entirely of the conductively doped resin-based material and then covered with an outer layer of non conductive resin-based material for electrical insulation. In another embodiment the ring loop connectors 114 are formed of the conductively doped resin-based material, metal plated and/or metal coated, and then covered with an outer layer of non conductive resin-based material. In one embodiment the ring loop connector 114 and the ring loop 112 are molded as a continuous piece of conductively doped resin-based material. In another embodiment the ring loop connector 114 is formed of the conductively doped resin-based material, and the ring loop 112 is metal. The ring loop 112 is soldered or otherwise electrically connected to the ring loop connector 114.

In one embodiment of the present invention the conductor 116 comprises the conductively doped resin-based material. In one embodiment the conductor 116 comprises the conductively doped resin-based material as the inner conductive core with an outer layer of non conductive resin-based material to provide electrical insulation. In another embodiment the conductor 116 comprises an inner conductive core of metal, a surrounding layer of conductively doped resin-based material, and an outer layer of non conductive resin-based material. In one embodiment the conductor 116, the ring loop connector 114, and terminal connector 118 are molded of a continuous piece of conductively doped resin-based material. In another embodiment the conductor 116 is metal while the ring loop connector 114 and terminal connector 118, are formed of the conductively doped resin-based material and are soldered or otherwise electrically connected to the conductor 106.

In one embodiment of the present invention the terminal connector 118 comprises the conductively doped resin-based material. In one embodiment the terminal connector 118 is formed entirely of the conductively doped resin-based material and then covered with an outer layer of non conductive resin-based material for electrical insulation. In another embodiment the terminal connector 118 is formed of the conductively doped resin-based material, metal plated and/or metal coated, and then covered with an outer layer of non conductive resin-based material.

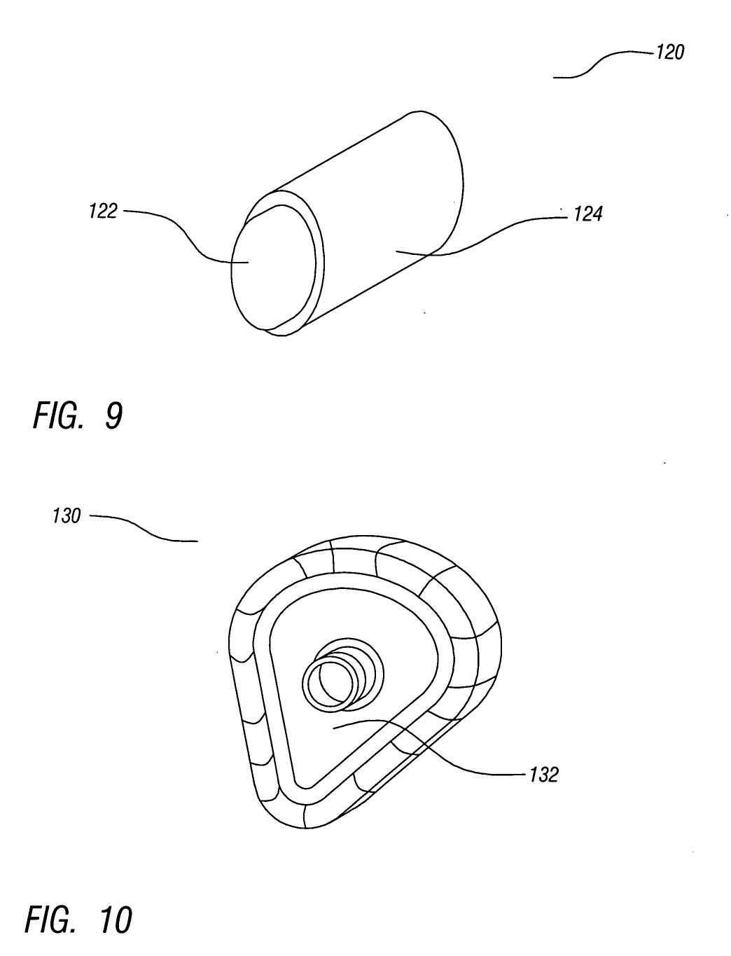

Referring now to FIG. 9, another embodiment of a medical device of the present invention is illustrated. An implantable, or insertable, medical camera capsule 120 is shown. The medical camera capsule 120 comprises the conductively doped resin-based material of the present invention. In various embodiments, the outer shell antenna 124, the internal antenna (not shown), the internal LED fixture (not shown), the internal circuit boards (not shown) and/or the external lens 122 are formed of the conductively doped resin-based material of the present invention. An FDA approved, medical grade resin is used for the base resin of the conductively doped resin-based material. The medical camera capsule 120 is preferably small enough to be swallowed and is useful to diagnose areas of the digestive tract. The capsule 120 has an internal power source that powers a camera with a built-in LED. The capsule 120 then transmits the images to a wearable receiver-storage device by a built-in radio transmitter and antenna.

In one embodiment, the outer shell 124 comprises the conductively doped resin-based material of the present invention. In one embodiment the outer shell 124 is formed of the conductively doped resin-based material and is designed to act as the transmitting antenna. An outer layer of non conductive resin-based material is then formed over the inner antenna layer to act as an insulator. In another embodiment the outer shell 124 is formed of a non conductive resin-based material and an internal antenna is formed of the conductively doped resin-based material separate from the outer shell 124. A wide variety of antenna structures are easily formed of the conductively doped resin-based material of the present invention. Monopole, dipole, geometric shapes, 2D, 3D, 4D, 5D, isotropic structures, planar, inverted F, PIFA, and the like, are all within the scope of the present invention. The antenna design can be molded by, for example, injection molding. The molded antenna shape determines the resonant frequency response of the antenna.

In one embodiment of the present invention the external lens 122 comprises the conductively doped resin-based material. In the embodiment, the external lens 122 is formulated with enough fiber in the resin matrix to allow for EMF shielding and heat dissipation and still retain the transparency needed for the camera. The wearable receiver-storage device, for the medical camera capsule 120 is not shown but it is understood that any component or several components of the receiving unit or units can be formed of the conductively doped resin-based material of the present invention.

Referring now to FIG. 10, an embodiment 130 of a medical device of the present invention is illustrated. An antistatic oxygen mask 132 is shown. The antistatic oxygen mask 132 comprises the conductively doped resin-based material of the present invention. An FDA approved, medical grade resin is used for the base resin of the conductively doped resin-based material. The need for antistatic properties is essential when dealing with oxygen masks, hoses, and fixtures. The conductively doped resin-based material is highly conductive and is capable of high frequency response to provide an excellent energy dissipation path. The conductively doped resin-based material of the present invention provides safe dissipation of electrostatic charges so that such charges cannot buildup and subsequently cause an explosion. The antistatic oxygen mask 132 is representative of any number of medical fixtures, structures, and the like designed to carry and/or facilitate flammable gasses and other substances that can benefit from the antistatic properties of the conductively doped resin-based material of the present invention.

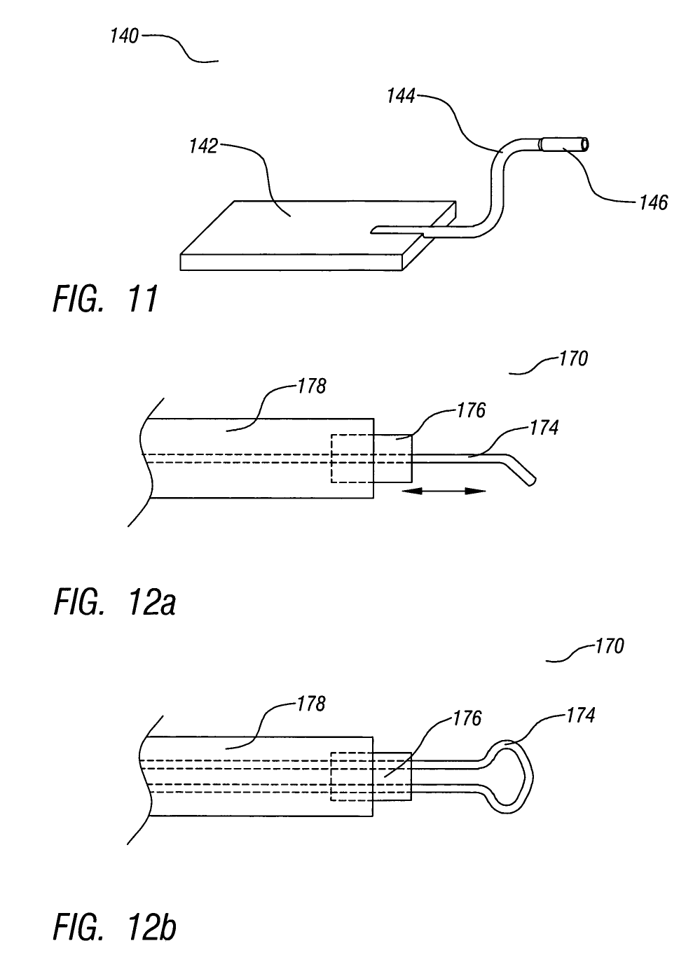

Referring now to FIG. 11, another embodiment of a medical device of the present invention is illustrated. A patch electrode 140 is shown. The patch electrode 140 comprises the conductively doped resin-based material of the present invention. The patch electrode 140 is useful for a variety of medical applications. For example, the patch electrode 140 can be used for heart pacing or defibrillation, nerve stimulation therapy, electro physiotherapy, and the like. In a nerve or muscle stimulation scenario, a low energy signal is transmitted from the electrical source through the electrode 140 and into the patient's skin. In a defibrillation scenario, a high energy pulse, or series of pulses, is transmitted through the electrode 140 and into the patient's skin in the chest region to re-establish proper heart rhythm, or beating. This high energy pulse is capable of briefly overwhelming the body's electrical system and of ‘jump starting’ the heart back into a proper rhythm. In various embodiments, conductive fabric 142, a conductor 144, and/or a connector 146 comprise the conductively doped resin-based material. An FDA approved, medical grade resin is used for the base resin of the conductively doped resin-based material.

In the preferred embodiment, the patch electrode 140 preferably comprises a flexible base resin material to thereby optimally fit the contour where applied to the patient's body. In this way, the conductive fabric 142 maximizes the contact area with the body and, therefore, the area of energy transfer. The conductively doped resin-based electrode 140 has several distinct advantages. First, a flexible and comfortable electrode 140 is fabricated from a medical grade resin. Second, the electrode 140 exhibits low resistivity due to the network of conductive fibers and is, therefore, capable of transferring significant electrical to the patient. Third, the conductive network in the polymeric matrix has a large frequency bandwidth such that rapid switching pulses and/or high frequency signals may be transmitted with little loss. Fourth, the resistivity of the conductively doped resin-based material allows effective resistance values to be molded into the electrode 140 design for power limiting. Fifth, the electrodes are easily formed using resin molding techniques such as injection molding or extrusion to facilitate ease of manufacture and low cost. Sixth, the conductively doped resin-based electrodes will spread out, or dissipate, the current better than prior art, wire-based electrodes due to the novel conductive matrix. As a result, a larger energy transfer is possible while reducing the occurrence of burning or discomfort.

In one embodiment the conductor 144 comprises the conductively doped resin-based material of the present invention. In one embodiment, the conductor 144 comprises a center conductive core of conductively doped resin-based material with an outer layer of non conductive resin-based material for electrical insulation. In another embodiment, the conductor 144 is formed with a center conductive core of the conductively doped resin-based material that is metal plated and/or metal coated and covered with an outer layer of non conductive resin-based material.

In one embodiment the connector 146 comprises the conductively doped resin-based material of the present invention. In one embodiment the connector 146 is formed entirely of the conductively doped resin-based material and covered with an outer insulating layer of non conductive resin-based material. In another embodiment the connector 146 is formed of the conductively doped resin-based material, metal plated and/or metal coated, and then covered with an outer insulating layer of non conductive resin-based material. In one embodiment the conductor 144 and the connector 146 are molded as a continuous piece of conductively doped resin-based material. In another embodiment the conductor 144 and the connector 146 are formed separately and then soldered or otherwise electrically connected.

Referring now to FIGS. 12a and 12b, another embodiment of a medical device is illustrated. An electric scalpel device 170 comprising a conductively doped resin-based material is shown. A side view is shown in FIG. 12a, and a top view is shown in FIG. 12b. A cutting electrode 174 is electrically connected to a power source, not shown. A bushing 176 is used to mechanical and electrically isolate the electrode 174 from a handle 178 or sleeve. Electric scalpels 170 provide two beneficial features over traditional scalpels. First, electric scalpels cut via localized heating of body tissue rather than via physical movement of a blade. Therefore, electric scalpels are ideal for operating in confined body spaces. Second, electric scalpels can be designed to provide cauterization of the incision such that stitches are not required. Again, this is very useful for operating in confined spaces.

In one embodiment, the scalpel electrode 174 comprises conductively doped resin-based material. Prior art electric scalpel electrodes comprise a thin metal wire. The present invention offers advantages of non-reactivity of the resin-based material with excellent conductivity and resistance control. In one embodiment, the electrode 174 preferably comprises a flexible base resin material to thereby optimally fit the contour where applied to the patient's body. Preferably, a medical grade resin-based material is used. The resistivity of the conductively doped resin-based material allows effective resistance values to be molded into the electrode 174 design for power limiting. The electrode 174 is easily formed using resin molding techniques such as injection molding or extrusion to facilitate ease of manufacture and low cost. The cutting electrode 174 may be molded into a simple loop 174, as shown, or any of a variety of other shapes and features including ridges, grooves, hooks, and the like, as is well known in the art. In one embodiment the electrode 174 comprises only conductively doped resin-based material of the present invention. In another embodiment, the electrode 174 is formed with a center conductive core of the conductively doped resin-based material that is metal plated and/or metal coated.

In one embodiment, the electric scalpel 170 is a resectoscope assembly. An electrode 174 is mounted within an isolation bushing 176. The isolation bushing 176 allows the electrode 174 to extend from and retract into a tube 178 or sleeve. The cutting electrode 174 is electrically connected to a power source, not shown. In a typical application, the resectoscope device 170 is inserted into an opening in the body with the electrode 174 retracted inside the tube 178. Once in position, the scalpel electrode 174 is then extended out of the tube 178 to perform the desired cutting.

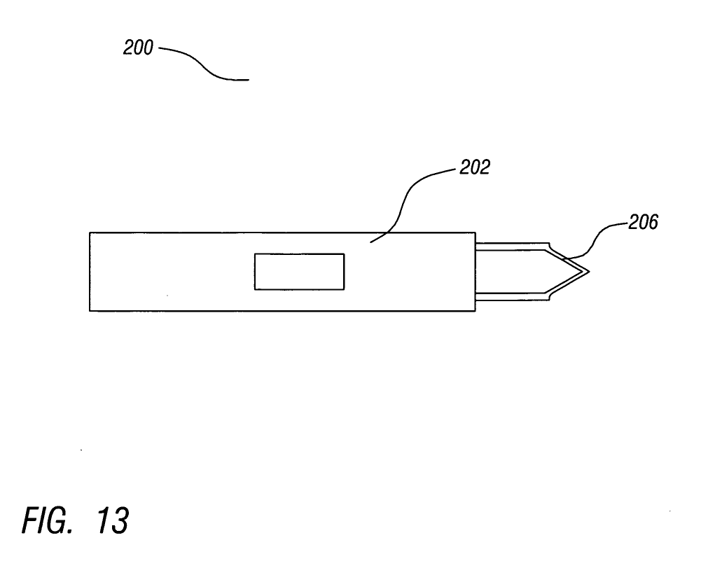

Referring now to FIG. 13, another embodiment of the present invention is illustrated. A cauterizing device 200 comprising a conductively doped resin-based material is shown. A cauterizing electrode 206 is electrically connected to a power source, not shown, that resides within, or is accessible through, a handle 202. The cauterizing device 200 is designed stop bleeding by localized heating of body tissue and blood.

In one embodiment, the cauterizing electrode 206 comprises conductively doped resin-based material. Prior art cauterizing electrodes comprise a thin metal wire. The present invention offers advantages of non-reactivity of the resin-based material with excellent conductivity and resistance control. In one embodiment, the electrode 206 preferably comprises a flexible base resin material to thereby optimally fit the contour where applied to the patient's body. Preferably, a medical grade resin-based material is used. The resistivity of the conductively doped resin-based material allows effective resistance values to be molded into the electrode 206 design for power limiting. The electrode 206 is easily formed using resin molding techniques such as injection molding or extrusion to facilitate ease of manufacture and low cost. The electrode 206 may be molded into a simple pointed loop 174, as shown, or any of a variety of other shapes and features including ridges, grooves, hooks, and the like, as is well known in the art. In one embodiment the electrode 206 comprises only conductively doped resin-based material of the present invention. In another embodiment, the electrode 206 is formed with a center conductive core of the conductively doped resin-based material that is metal plated and/or metal coated.

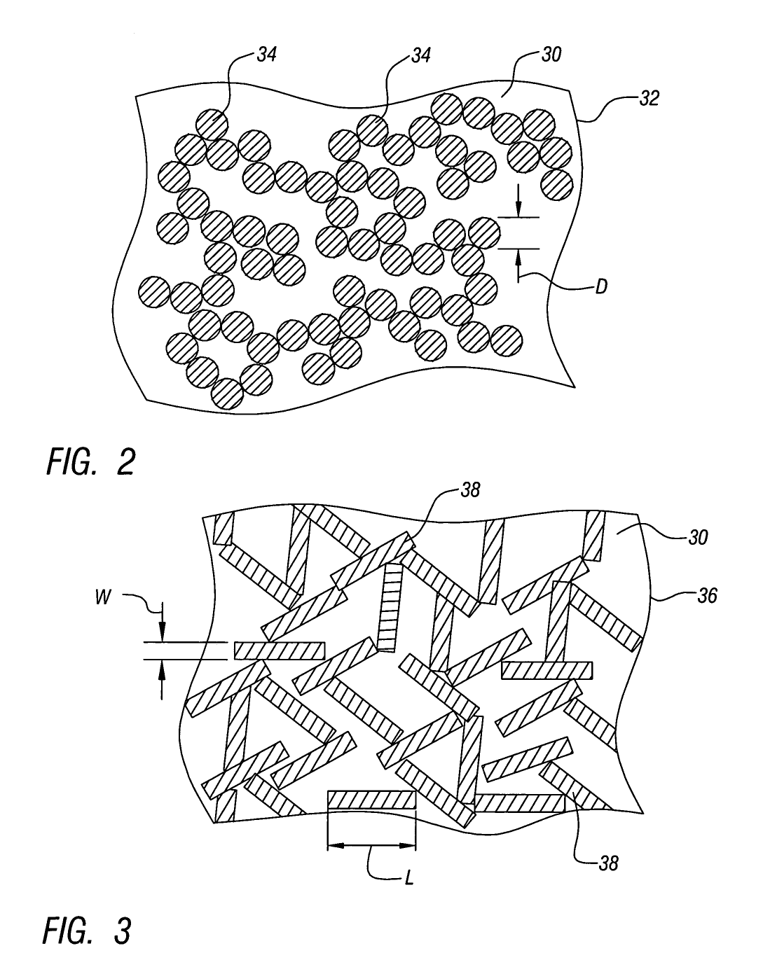

The conductively doped resin-based material typically comprises a micron powder(s) of conductor particles and/or in combination of micron fiber(s) substantially homogenized within a base resin host. FIG. 2 shows a cross section view of an example of conductively doped resin-based material 32 having powder of conductor particles 34 in a base resin host 30. In this example the diameter D of the conductor particles 34 in the powder is between about 3 and 12 microns.

FIG. 3 shows a cross section view of an example of conductively doped resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

These conductor particles and/or fibers are substantially homogenized within a base resin. As previously mentioned, the conductively doped resin-based materials have a sheet resistance of less than about 5 to more than about 25 ohms per square, though other values can be achieved by varying the doping parameters and/or resin selection. To realize this sheet resistance the weight of the conductor material comprises between about 20% and about 50% of the total weight of the conductively doped resin-based material. More preferably, the weight of the conductive material comprises between about 20% and about 40% of the total weight of the conductively doped resin-based material. More preferably yet, the weight of the conductive material comprises between about 25% and about 35% of the total weight of the conductively doped resin-based material. Still more preferably yet, the weight of the conductive material comprises about 30% of the total weight of the conductively doped resin-based material. Stainless Steel Fiber of 6-12 micron in diameter and lengths of 4-6 mm and comprising, by weight, about 30% of the total weight of the conductively doped resin-based material will produce a very highly conductive parameter, efficient within any EMF, thermal, acoustic, or electronic spectrum.

In yet another preferred embodiment of the present invention, the conductive doping is determined using a volume percentage. In a most preferred embodiment, the conductive doping comprises a volume of between about 4% and about 10% of the total volume of the conductively doped resin-based material. In a less preferred embodiment, the conductive doping comprises a volume of between about 1% and about 50% of the total volume of the conductively doped resin-based material though the properties of the base resin may be impacted by high percent volume doping.

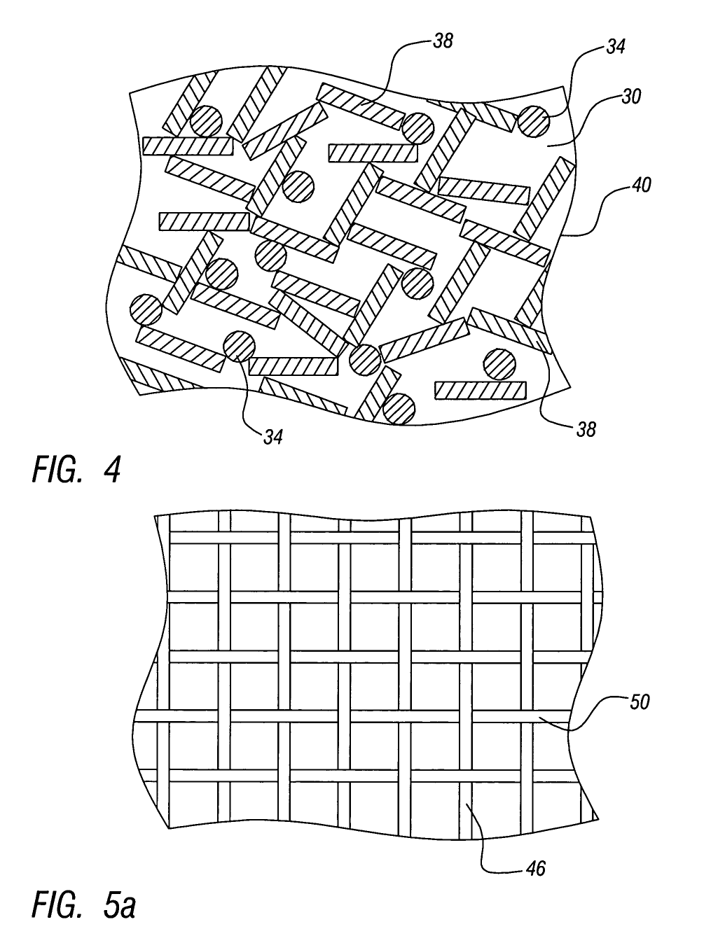

Referring now to FIG. 4, another preferred embodiment of the present invention is illustrated where the conductive materials comprise a combination of both conductive powders 34 and micron conductive fibers 38 substantially homogenized together within the resin base 30 during a molding process.

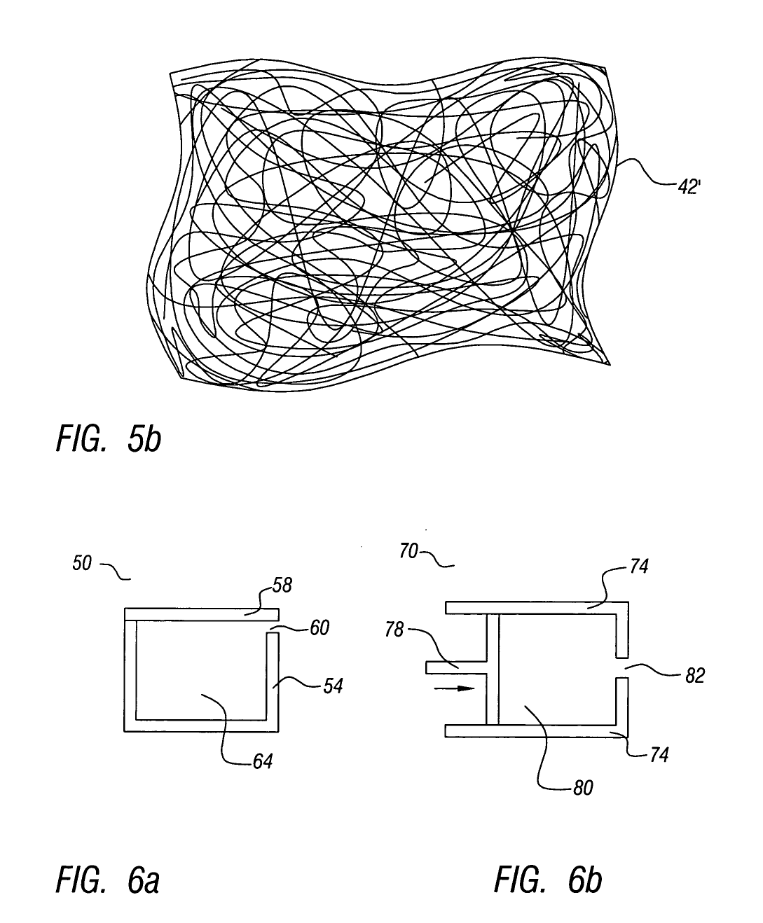

Referring now to FIGS. 5a and 5b, a preferred composition of the conductively doped, resin-based material is illustrated. The conductively doped resin-based material can be formed into fibers or textiles that are then woven or webbed into a conductive fabric. The conductively doped resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Articles formed from conductively doped resin-based materials can be formed or molded in a number of different ways including injection molding, extrusion, calendaring, compression molding, thermoset molding, or chemically induced molding or forming. FIG. 6a shows a simplified schematic diagram of an injection mold showing a lower portion 54 and upper portion 58 of the mold 50. Conductively doped resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 6b shows a simplified schematic diagram of an extruder 70 for forming articles using extrusion. Conductively doped resin-based material(s) is placed in the hopper 80 of the extrusion unit 74. A piston, screw, press or other means 78 is then used to force thermally molten, chemically-induced compression, or thermoset curing conductively doped resin-based material through an extrusion opening 82 which shapes the thermally molten curing or chemically induced cured conductively doped resin-based material to the desired shape. The conductively doped resin-based material is then fully cured by chemical reaction or thermal reaction to a hardened or pliable state and is ready for use. Thermoplastic or thermosetting resin-based materials and associated processes may be used in molding the conductively doped resin-based articles of the present invention.

The advantages of the present invention may now be summarized. An effective medical device is achieved. A method to form a medical device is achieved. A medical device may be molded of conductively doped resin-based materials. An electrical stimulation device may comprise conductively doped resin-based materials. A probe device may comprise conductively doped resin-based material. A radio transmitting or receiving device may comprise conductively doped resin-based material. An anti-static breathing mask device may comprise conductively doped resin-based material. An electrode patch device may comprise conductively doped resin-based material. An electric scalpel device may comprise conductively doped resin-based material. A cauterization device may comprise conductively doped resin-based material. A medical device may be molded of conductively doped resin-based material where the thermal, electrical, acoustical, or electromagnetic characteristics can be altered or the visual characteristics can be altered by forming a metal layer over the conductively doped resin-based material. The medical device may be molded from a conductively doped resin-based material incorporating various forms of the material. A medical device may be fabricated from a conductively doped resin-based material where the material is in the form of a fabric.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the scope of the invention.

What is claimed is:

1. A medical device comprising:
an electrical power source; and
a conductive interface to body tissue that is electrically coupled to said electrical power source wherein said conductive interface comprises a conductively doped resin-based material comprising conductive materials in a base resin host.

2. The device according to claim 1 wherein the percent by weight of said conductive materials is between about 20% and about 50% of the total weight of said conductively doped resin-based material.

3. The device according to claim 1 wherein said conductive materials comprise micron conductive fiber.

4. The device according to claim 3 wherein said conductive materials further comprise conductive powder.

5. The device according to claim 1 wherein said conductive materials are metal.

6. The device according to claim 1 wherein said conductive materials are non-conductive materials with metal plating.

7. The device according to claim 1 wherein said conductive interface to body tissue is a fabric pad of said conductively doped resin-based material.

8. The device according to claim 1 wherein said conductive interface to body tissue is a loop of said conductively doped resin-based material.

9. The device according to claim 1 wherein said electrical power source has a case comprising said conductively doped resin-based material.

10. The device according to claim 1 further comprising a metal layer overlying said conductively doped resin-based material.

11. The device according to claim 1 wherein said conductive materials comprises ferromagnetic material.

12. The device according to claim 1 wherein said conductive interface to body tissue provides electrical stimulation.

13. The device according to claim 1 wherein said conductive interface to body tissue provides electrical-based cutting.

14. The device according to claim 1 wherein said conductive interface to body tissue provides heat cauterization.

15. A medical device comprising:
an enclosure that is implanted into body tissue;
a radio circuit capable of receiving or transmitting wherein said radio circuit is within said enclosure; and
an antenna coupled to said radio circuit wherein said antenna comprises a conductively doped resin-based material comprising conductive materials in a base resin host.

16. The device according to claim 15 wherein the percent by weight of said conductive materials is between about 20% and about 50% of the total weight of said conductively doped resin-based material.

17. The device according to claim 15 wherein said conductive materials comprise micron conductive fiber.

18. The device according to claim 17 wherein said conductive materials further comprise conductive powder.

19. The device according to claim 15 wherein said conductive materials are metal.

20. The device according to claim 15 wherein said conductive materials are non-conductive materials with metal plating.

21. The device according to claim 15 wherein said device is small enough to be swallowed.

22. The device according to claim 15 further comprising a metal layer overlying said conductively doped resin-based material.

23. The device according to claim 15 wherein said antenna is part of said enclosure.

24. A medical device comprising:
a gas source; and
a face mask operably coupled to said gas source such that gas flows from said gas source and through said face mask and wherein said face mask comprises said conductively doped resin-based material.

25. The device according to claim 24 wherein the percent by weight of said conductive materials is between about 20% and about 50% of the total weight of said conductively doped resin-based material.

26. The device according to claim 24 wherein said conductive materials comprise micron conductive fiber.

27. The device according to claim 26 wherein said conductive materials further comprise conductive powder.

28. The device according to claim 24 wherein said conductive materials are metal.

29. The device according to claim 24 wherein said conductive materials are non-conductive materials with metal plating.

30. The device according to claim 24 further comprising a metal layer overlying said conductively doped resin-based material.
